(19) United States
(12) Patent Application Publication
(10) Pub. No.: US 2023/0196425 A1
(43) Pub. Date: Jun. 22, 2023

(54) LINKING USER BEHAVIORS TO TRACKED DATA CONSUMPTION USING DIGITAL TOKENS

(71) Applicant: PAYPAL, INC., San Jose, CA (US)

(72) Inventor: Pankaj Sarin, Fremont, CA (US)

(21) Appl. No.: 17/558,335

(22) Filed: Dec. 21, 2021

(51) Int. Cl. G06Q 30/06; G06V 20/40

(52) U.S. Cl. CPC G06Q 30/0601; G06V 20/40

(57) ABSTRACT

There are provided systems and methods for linking user behaviors to tracked data consumption using digital tokens. A service provider, such as an online transaction processor, may provide additional services to users via a media content monitoring and/or tokenization system for purchasable items in media content. A user may view media content and see an item available for purchase. One or more IoT sensors, routers or devices, and the like may be used to identify the user viewed the item in the media content. This data may be tokenized as a shopping object digital token, which may be cached for a time period to detect if the user's behaviors indicate that the user purchases another related item based on viewing the item in the media content. If the user processes a transaction for the related item, rewards may be provided to participants involved in presenting and selling that item.

### TECHNICAL FIELD

The present application generally relates to media content including digital presentations and/or digital objects of purchasable items, and more particularly to detecting viewing of purchasable items in media content using Internet of Things (IoT) sensors or similar devices for generating digital shopping object tokens of those items.

### BACKGROUND

Users may utilize various mobile computing devices, such as tablet computers, smart phones, and wearable computing devices, to perform computing operations and communications. Computing devices may be used to view, listen to, or otherwise consume media content. Users may also utilize computing devices, for example, to perform electronic transaction processing, order and/or purchase items, view content, search for items and services, and the like. The media content may include purchasable items that a user may view or hear, and the user may decide to purchase the same or similar item. For example, a user may view a television show with a food item in a scene, such as an actor purchasing or eating ice cream. However, mobile computing devices do not have a process to track when users consume media content and identify, view, and/or hear of purchasable items in media content. Thus, entities that are associated with the media content and/or purchase of an item do not have processes to link real-world user behaviors to presentations of items in media content, which may reduce the number of potential transactions for the entity.

### BRIEF DESCRIPTION OF THE DRAWINGS

FIG. 1 is a block diagram of a networked system suitable for implementing the processes described herein, according to an embodiment;

FIG. 2 illustrates exemplary interactions between devices and servers of users and other entities when tracking user behaviors with shopping object tokens, according to an embodiment;

FIG. 3 is an exemplary environment where a user may view media content having purchasable items that may be tokenized as shopping object tokens for user behavior tracking, according to an embodiment;

FIG. 4 is a flowchart for linking user behaviors to tracked data consumption using digital tokens, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for linking user behaviors to tracked data consumption using digital tokens. Systems suitable for practicing methods of the present disclosure are also provided.

A service provider, such as an online transaction processor, may detect that a user is consuming or has consumed media content, such as viewing, watching, listening to, or the like of movies, television shows, other videos, images, recordings, music, podcasts, and/or other media content. In the media content, one or more items may be present that may be purchasable by the user. For example, the content may generally be present when another user in the media content interacts with the item, may be advertised to the user, or may otherwise be present as a digital object, item occurring in a scene, or the like. As discussed herein, items may correspond to products, services, goods, and/or other items that may appear in media content and also be purchasable. The service provider may detect that a purchasable item is present in the media content consumed by the user and viewed or heard by the user through one or more IoT sensors, devices, routers, servers, or the like. Once presented to the user in the media content, a digital shopping object token, such as an IoT shopping object token (ISO token), may be generated for the item. The digital token may be cached for a period of time and with a discrete media consumption session (e.g., viewing session) for the media content consumed by the user. The token may further include metadata associated with viewing or hearing the presentation of the item, which may include information about how the item was presented, when or where the item was presented, if there is an advertiser or other presenter of the media content, the producers or creators of the media content, and the like.

Thereafter, while the digital token is cached, the user may perform a purchase of the same or similar item. For example, if the user views an actor eating a particular brand of ice cream, the user may then perform user behaviors that indicate that the user purchased an item based on consuming the media content where the item was presented. In this example, the user may access a food delivery application and have the brand of ice cream delivered from a nearby grocery store. With non-consumable items, such as electronics, clothing or apparel, and the like, the digital token may be cached for a longer period and the user may visit a store later where the user purchases a same or similar item, such as the presented item, a same brand of the item, or the like. Detection of the user behaviors may be done through application and/or device interactions, electronic transaction processing and/or transaction histories, IoT sensors and/or devices, shopping or merchant marketplace websites and/or platforms, and the like. When detected, the service provider may then determine incentives, rewards, and/or a portion of the sale price of the item to provide to each user, party, or entity involved in the transaction. For example, creators of and/or users in the media content, advertisers, providers or streamers of the media content, online transaction processors, producers and/or sellers of the media content, and the like may be identified. Each entity may then receive the reward or a portion of the reward, where the corresponding reward(s) for each entity may be determined based on one or more rules, preferences, or settings. Thus, linking user behaviors to digital tokens may provide a new reward system in an automated and coordinated manner.

In order for users to utilize these services, an online service provider (e.g., an online transaction processor, such as PAYPAL®) may provide account services to users of the online service provider, as well as other entities requesting the services. A user wishing to establish the account may first access the online service provider and request establishment of an account. An account and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including payment card (e.g., credit/debit card) information, bank account information, gift card information, benefits/incentives, and/or financial investments. This information may be used to process transactions for items and/or services including purchases associated with digital ISO tokens created for purchasable items in media content. Further, the incentives and/or rewards may be provided to accounts and/or digital wallets by the service provider when providing rewards to entities involved in a purchase associated with an ISO token. In some embodiments, the account creation may establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services. However, other service providers may also provide all or part of the computing services and resources discussed herein through IoT devices, software development kits (SDKs), mobile and/or software applications, websites, routers and services, and the like.

Once the account of a user is established with the service provider, the user may utilize the account via one or more computing devices, such as a personal computer, tablet computer, mobile smart phone, or the like. The user may engage in one or more online or virtual interactions that may be associated with electronic transaction processing, images, music, media content and/or streaming, video games, documents, social networking, media data sharing, microblogging, and the like. The user may utilize a computing device to consume media content, such as by viewing a video or images and/or listening to audio. Within the media content, one or more items may be present, which may be purchasable. This may correspond to small and/or singular purchases, such as food, drinks, and other consumables, as well as larger and/or more expensive items from electronics, apparel, jewelry, to vehicles and the like. When viewing media content, items that are purchasable in the media content may be identified based on data and/or metadata for the media content. For example, identifiers, descriptions, and/or other item data may be added to and associated with the media content so that when the media content is consumed, the device presenting the media content and/or detecting the presentation of the media content may identify purchasable items based on the media content's data and/or metadata.

In some embodiments, the item's identification may also be determined from the media content, such as using one or more IoT sensors. Networked data sensors may be incorporated in different types of devices, locations, and objects to provide a network of embedded sensors. For example, the IoT system may correspond to a broad network of systems, sensors, applications, and devices that function together to monitor real-world data. In this regard, the network of sensors may be capable of detecting user data for a user, such as a location of the user, action that the user takes with an item or device, and the like. IoT sensors may also detect information about presentation of media content, such as by capturing video or images of the presentation, detecting and/or recording audio, and the like. The sensors may include motion sensors, cameras, microphones, or any other type of device that may be capable of detecting information, data, or content and communicating with devices. Certain devices may also include certain devices including an Internet router, a television provider device, a mobile smart phone, an IoT home device, or the like. The networked sensors may also be capable of communicating with a device of the user to send and receive data, as well as detect data on the device (e.g., whether the user has a token stored on the device). The networked sensors may be incorporated within a network that may communicate with other service providers and entities, such as a tokenization system provided by a service provider and a merchant device at a merchant location.

In some embodiments, an edge computing system may be used to provide a local network for a user that stores data, including caching tokens and/or detecting media content having purchasable items. An edge computing system may correspond to an auxiliary cloud computing system that may provide one or more edge computing nodes that are location-specific and provided on a network closer to the location so that data may be served faster and with lower latency to computing devices associated with the location. Edge computing may correspond to a general or specific-purpose compute, storage, and other operations to utilize those components, closer to end users on a network and/or using IoT endpoints. In one embodiment, an edge computing node may be provided by a cellular network (e.g., 5G, however, other cellular networks may also be utilized). Edge computing systems and nodes may also be provided by cloud computing systems, such as Amazon AWS®, Microsoft Azure®, and the like. When configuring IoT sensors, home devices, media output devices, and/or edge computing systems, one or more SDKs my be provided by the service provider that provides ISO tokens for purchasable items in media content and/or electronic transaction processing for those items that are associated with ISO tokens,

In various embodiments, once a purchasable item in media content is detected by the service provider using IoT sensors or other devices, routers, or servers, a digital token may be generated for the item as a shopping object. This may correspond to an ISO token, where data representing the item is tokenized. The data may further be associated with the media content, metadata for the media content and/or item presented in the media content (e.g., parameters of presentation including time of presentation, actor/advertiser of the media content, location or effect of presentation, etc.). Such data and/or metadata may then be tokenized and the corresponding ISO token for the purchasable item and corresponding shopping object may be cached. In some embodiments, the ISO token may be associated and/or tokenized with incremental data for the item, including a price of the shopping object, a tenant presenting the media content (e.g., a streaming service, television provider, etc.), time credential for viewing of the media content and/or item, and/or a private key that allows identification of the user associated with the digital ISO token.

When caching the token, the token may be cached to a device associated with the user, an edge storage node, an IoT device, and/or with an account provided by the service provider. Caching may be performed for the token for a time period, which may be based on the item and shopping object. For example, less expensive, smaller, and/or consumable items may be cached for a shorter amount of time, such as a day or week, while more expensive or larger purchases may be cached longer, such as a month or even persistently stored for a year or longer, where the user may take longer to consider purchasing of the item. The item's digital token may also be cached into discreet sessions, such as media consumption sessions, for viewing sessions of media content, which allows association of the digital token with the media content. In various embodiments, the token may be shared with other nearby users' devices, such as those users that may have also consumed the media content (e.g., other viewers of a movie, a neighbor that may overhear the media content, etc.). This may allow other users' behaviors to be linked to viewing or hearing of the item for further associating user behaviors with digital ISO tokens and purchases of items associated with the ISO tokens.

Once tokenized and cached, user behaviors and/or activities may be monitored to determine if the user considers and/or processes a purchase of the item. These behaviors and/or activities may be associated and/or cached with the digital ISO tokens, which may be used to score a purchase of the item and determine whether consuming the media content that presented the item to the user caused the user to effectuate a purchase of the item. For example, activity and behaviors of users may be monitored by IoT sensors, mobile devices, Internet routers, media streaming or viewing devices (e.g., smart televisions, cable television boxes, etc.), point-of-sale (POS) devices, merchant terminals, and the like. Activities may include executing a search or query for the item with a search engine or in an application, viewing the item in applications or on websites, reading descriptions or other information about the item, messaging or email one or more other users or merchants about the items, and the like. Additionally, the behaviors and activities may include reviewing the item in a merchant application or on a merchant marketplace in order to purchase the item, view costs to purchase the item, and the like. These behaviors and activities may be temporally related to the item and shopping object based on the amount or length of time that the ISO token is cached.

Thereafter, the service provider may detect and/or determine a purchase of the item from a merchant. This may occur from a merchant and/or item purchase/delivery application or website. This may include adding items to a digital shopping cart and performing a checkout through a checkout and payment flow. Further, purchases may also be performed at physical merchant locations. Thus, in different embodiments, the location of the purchase may correspond to a merchant location (e.g., a retail storefront, a shopping center, or the like), within a delivery service application, in a merchant application or on a merchant website, or the like. The purchase may then be linked to the digital ISO token based on the item type, brand, description, or the like. For example, a same or similar item may be purchased. Further, the purchase may be determined to be linked to the consumption of the media content, such as based on the behaviors and/or activities of the user and/or based on the time period during which the ISO token is cached and associated with the user consuming the media content. Thus, the service provider may determine that the cause of the user purchasing the item is linked to the media content presenting the item to the user using the ISO token cached for the user. The service provider, such as an online transaction processor, may then use a payment instrument, account, and/or digital wallet of the user to perform electronic transaction processing for the item with the merchant selling the item.

Prior to, during, or after the purchase of the item by the user, the service provider may further determine a pricing, incentive, and/or reward component and system to provide an incentive, a reward, or one or more shares of the sale price and/or user payment to provide to different entities associated with the media content presenting the purchased item and/or selling the purchased item to the user. For example, different shares in a reward or other payment may be determined based on the different entities involved in providing the media content and/or selling the item, including a merchant, a tenant streaming or presenting the media content, a producer or creator of the media content, users or entities in the media content, and/or a producer of the item sold to the user. The amount or share to provide each participant entity in the presenting and selling of the item may be dynamic based on the number of the participants, the behaviors or activities of the user, and/or the presentation and/or sale of the item to the user. Further, reward or payment rules, settings, and/or preferences may be used to determine and/or calculate shares to provide the participants. Once determine, the shares of the reward and/or payment may be released to those participant entities.

In this manner, a service provider may provide automated rewards and/or payment systems for entities involved in presenting media content and/or selling items presented in the media content. This may utilize a coordinated system of devices, servers, IoT sensors, and the like to provide detection of items presented in media content and tokenization of data for the items to ISO tokens for shopping objects. Thus, the service provider may provide coordinated data communications for different tokenization operations of shopping objects from media content and faster proliferation of tokens and rewards in a reward system without requiring manual efforts and user input.

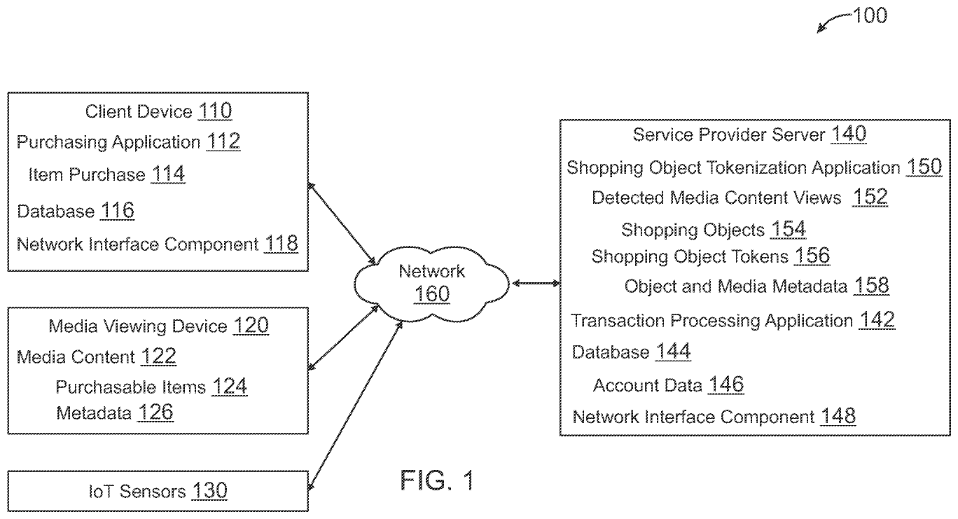

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways, and that the operations performed, and/or the services provided by such devices and/or servers, may be combined or separated for a given embodiment and may be performed by a greater number or fewer number of devices and/or servers. One or more devices and/or servers may be operated and/or maintained by the same or different entities.

System 100 includes a client device 110, a media viewing device 120, IoT sensors 130, and a service provider server 140, in communication over a network 160. Client device 110 may be used to establish an account with service provider server 140 and/or another service provider, which may be used for electronic transaction processing of items that may be presented in media content viewed by a user. Service provider server 140 may detect viewing of the media content and items in the media content from media viewing device 120 using IoT sensors 130, which may then tokenize shopping objects for those items. The ISO tokens generated from the shopping objects may then be used to determine when client device 110 is used to process a purchase of the item for proliferation of rewards and/or payments.

Client device 110, media viewing device 120, IoT sensors 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Client device 110 may be implemented using any appropriate hardware and software configured for wired and/or wireless communication with media viewing device 120, IoT sensors 130, and service provider server 140 for data communications, which may include processing transactions for items presented in media content, which may be tracked and correlated to ISO tokens generated for the presented items. Client device 110 may correspond to an individual user, consumer, or entity that utilizes a platform provided by service provider server 140 for data storage, processing, and retrieval. In various embodiments, client device 110 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing device may function similarly.

Client device 110 of FIG. 1 contains a purchasing application 112, a database 116, and a network interface component 118. Purchasing application 112 may correspond to executable processes, procedures, and/or applications with associated hardware. In other embodiments, client device 110 may include additional or different software as required.

Purchasing application 112 may correspond to one or more processes to execute software modules and associated components of client device 110 to provide features, services, and other operations for a user over network 160, which may include electronic transaction processing via purchasing application 112 for an item presented in media content viewed by the user. In this regard, purchasing application 112 may correspond to specialized software utilized by a user of client device 110 that may be used to access a website or UI to perform actions or operations. In various embodiments, purchasing application 112 may correspond to a general browser application configured to retrieve, present, and communicate information over the Internet (e.g., utilize resources on the World Wide Web) or a private network. For example, purchasing application 112 may provide a web browser, which may send and receive information over network 160, including retrieving website information (e.g., a website for a merchant), presenting the website information to the user, and/or communicating information to the website. However, in other embodiments, purchasing application 112 may include a dedicated application of service provider server 140 or other entity (e.g., a merchant).

Purchasing application 112 may be associated with account information, user financial information, and/or transaction histories. This may be based on a transaction generated by purchasing application 112 for item purchase 114 using a merchant website and/or when engaging in transaction processing at a physical merchant location. For example, a transaction may be generated, initiated, and/or detected by service provider server 140 and/or another online transaction processor for item purchase 114, which may be based on user behaviors and/or activities detected by service provider server 140. Purchase of the item may also include searching for and/or otherwise engaging in behaviors that may indicate that the user is interested in the item. The item may be associated with an ISO token generated when the item is viewed in a media content, which may correspond to a tokenization of a shopping object for the item and/or other data or metadata associated with the item.

In some embodiments, purchasing application 112 may receive a notification and/or advertisement for the item and/or shopping object based on creation of the ISO token by service provider server 140. Thereafter, purchasing application 112 may be used to electronically process item purchase 114 with service provider server 140. Purchasing application 112 may also be used to receive a receipt or other information based on transaction processing of item purchase 114. Based on processing item purchase 114, one or more rewards may be provided to participants and/or entities associated with the ISO token. In further embodiments, different services may be provided via purchasing application 112, including messaging, social networking, media posting or sharing, microblogging, data browsing and searching, online shopping, and other services available through service provider server 140. Thus, purchasing application 112 may also correspond to different service applications and the like including item ordering, purchasing, and/or delivering, as well as merchant and/or marketplace applications.

Client device 110 may further include database 116 which may include, for example, identifiers such as operating system registry entries, cookies associated with purchasing application 112 and/or other applications, identifiers associated with hardware of client device 110, or other appropriate identifiers. Identifiers in database 116 may be used by a payment/service provider to associate client device 110 with a particular account maintained by the payment/service provider, such as service provider server 140. Database 116 may also further store user activities, inputs, and/or other behaviors that may be associated with viewing media content and/or digital objects of purchasable items in the media content. Data for a shopping object for the item may be tokenized as an ISO token, which may be stored to client device 110, another IoT device, and/or another device or server for use with tracking the behaviors of the user that are linked to the item and ISO token.

Client device 110 includes at least one network interface component 118 adapted to communicate with media viewing device 120, IoT sensors 130, service provider server 140, and/or other devices and/or servers over network 160. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Media viewing device 120 may correspond to a device that may be used by a user to consume media content. In this regard, media viewing device 120 may include a display, speakers, and/or other output components, as well as input components to select and/or request output of media content. For example, media viewing device 120 may correspond to and/or be associated with a television, a smart television, a computing device including mobile smart phones, a streaming device and/or component, a cable television provider device, a Blue-Ray, DVD, or other physical media player, and the like. Media viewing device 120 may therefore output media content 122, which may correspond to video, images, and/or audio including movies, television shows, other videos or presentations, images, recordings, music, podcasts, and/or other media content. During presentation of media content 122, purchasable items 124 may be presented in media content 122, for example, in a scene, based on voice of a user in media content 122, as an advertisement, or the like. Purchasable items 124 may be associated with metadata 126, which may correspond to additional and/or incremental data that describes or identifies purchasable items 124, presentation and output of purchasable items 124 in media content 122 (e.g., time, location, description, etc.), corresponding shopping objects and/or merchants for purchasable items 124, and/or other data that provides information about aspects and parameters of purchasable items 124. However, in other embodiments, media viewing device 120 may correspond to the same device as client device 110, such as a personal computer, tablet computer, mobile smart phone, or the like that may provide presentation, viewing, and/or listening to media content 122 having purchasable items 124 and metadata 126.

IoT sensors 130 may be provided, maintained, and/or configured (e.g., using an SDK) by an online service provider, which may provide a network of connected sensors, devices, and communicators that function to track real-world data, communicate with devices, and issue ISO tokens to track user behaviors, shopping objects, and/or purchases associated with purchasable items 124 presented in media content 122. In this regard, IoT sensors 130 includes one or more sensors and processing applications which may be configured to interact with client device 110 and/or another device/server to facilitate detection of real-world data including output of media content 122 and presentation of purchasable item 124 in media content 122. In one example, IoT sensors 130 may be provided by PAYPAL®, Inc. of San Jose, Calif., USA.

IoT sensors 130 may correspond to a data sensor capable of detecting user data of a user and presentations of media content, as well as determining or identifying items presented in the media content that are purchasable by the users. In various embodiments, IoT sensors 130 may include a camera, which corresponds to an optical device enabling IoT sensors 130 to capture or record images, including still and/or video images. IoT sensors 130 may correspond to a digital camera or may more generally correspond to any device capable of capturing or recording an image, video, or other digital media data, including infrared imaging or other types imaging devices. As a digital camera, IoT sensors 130 may include a sensor array disposed on a semiconductor substrate having a plurality of photosensitive elements configured to detect incoming light. In other embodiments, other types of electromagnetic radiation sensors may be used, including infrared sensitive sensors/elements and the like. A camera of IoT sensors 130 may include various features, such as zoom, flash, focus correction, shutter speed controls, or other various features usable to capture one or more images or videos of the user and/or other users or objects. IoT sensors 130 may include other media capture components, including a microphone to capture audio data. The microphones may be capable of capturing and/or recording audio data, which may be used in connection with a camera to identify media content presentations and items presented in the media content.

In certain embodiments, IoT sensors 130 may include a location detection component capable of detecting a location of a user and/or media content presentation, for example, through a GPS locator and service, triangulation process, mapping application, check-in process/feature, wireless communications, or other location detection process. IoT sensors 130 may also include IoT home devices, Internet routers, television presentation boxes and/or controllers, wireless data communication devices, and the like, which may be used to detect streaming and/or output of media content and the purchasable items in the media content. Further, such devices, routers, and the like may also be used to monitor and/or detect user behaviors and activities when interacting with and/or purchasing shopping objects, such as those associated with purchasable items 124 in media content 122. IoT sensors 130 may further include other types of devices and/or sensors that may capture data of the user and/or client device 110, such as a motion capture component, merchant and/or point-of-sale devices, and/or a data sensor and communicator that may capture processes being executed by client device 110. IoT sensors 130 may also include software components that may interact with the hardware components to facilitate data determination, such as radar and camera controllers.

Service provider server 140 may be maintained, for example, by an online service provider, which may provide operations for tokenizing data representing purchasable items presented in media content to users. Various embodiments of the processes described herein may be provided by service provider server 140 and may be accessible by client device 110 when interacting with media viewing device 120 and/or IoT sensors 130. In such embodiments, service provider server 140 may interface with client device 110 for utilizing ISO tokens and/or tracking user behaviors linked to the ISO tokens. Service provider server 140 includes one or more processing applications which may be configured to interact with client device 110, media viewing device 120, and/or IoT sensors 130 In one example, service provider server 140 may be provided by PAYPAL®, Inc. of San Jose, Calif., USA. However, in other embodiments, service provider server 140 may be maintained by or include another type of service provider.

Service provider server 140 of FIG. 1 includes a shopping object tokenization application 150, a transaction processing application 142, a database 144, and a network interface component 148. Shopping object tokenization application 150 and transaction processing application 142 may correspond to executable processes, procedures, and/or applications with associated hardware. In other embodiments, service provider server 140 may include additional or different modules having specialized hardware and/or software as required.

Shopping object tokenization application 150 may correspond to one or more processes to execute modules and associated specialized hardware of service provider server 140 to provide data, operations, and processes for detection of presentation of one or more items in one or more media contents that may be purchasable by a user. Shopping object tokenization application 150 may further be used to determine one or more shopping objects, item data, and/or item/media content metadata to generate digital ISO tokens representing the shopping object(s) for those items. Using these ISO, shopping object tokenization application 150 may allow one or more processes, applications, and/or platforms to correlate user behaviors and/or activities, including purchases, to those ISO tokens in order to provide rewards, shares of a payment or purchase price, or the like to different entities involved in the presentation of the media content and items in the media content and/or processing of a transaction for an item associated with an ISO token.

In this regard, shopping object tokenization application 150 may correspond to specialized hardware and/or software used by a user associated with client device 110 to establish an account with shopping object tokenization application 150 and/or access another account with service provider server 140 or another service provider. For example, an account provided by PAYPAL® may be utilized to provide services to users. However, a more general account (e.g., email, mobile service provider, merchant account, item purchase and/or delivery service account, etc.) may also provide the aforementioned account services when utilizing shopping object tokenization application 150. In other embodiments, shopping object tokenization application 150 may further utilize account data 146 stored by database 144 for services to provide shopping object tokenization and user behavior linking to ISO tokens, as described herein.

For example, shopping object tokenization application 150 may interface with client device 110, media viewing device 120, and/or IoT sensors 130 to detect, receive, and/or determine information associated with media content viewing and/or item purchasing. Shopping object tokenization application 150 may determine media content 122 is being viewed, such as through client device 110, media viewing device 120, and/or IoT sensors 130. During viewing of media content 122, purchasable items 124 may be detected as being presented to the user viewing media content 122. This may be done through cameras, microphones, and the like, as well as through Internet routers, IoT home devices, media presentation controllers, and the like, that correspond to client device 110, media viewing device 120, and/or IoT sensors 130. Detected media content views 152 may include one or more views of media content 122 and/or other media content. Detected media content views 152 may include presentations of media content to different users, which may be detected through sensors, devices, routers, servers, and the like.

For detected media content views 152, shopping objects 154 may be determined that correspond to the digital representations or objects of items presented in media content. In some embodiments, shopping objects 154 may be generated for purchasable items 124, such as by having item and/or shopping data and/or metadata (e.g., metadata 126) that may be used to identify an item associated with purchasable items 124, including when such an item is purchased. The item may be the same or similar (e.g., by type, brand, description, etc.) as one of purchasable items 124. In order to create and/or generate ISO tokens for shopping objects 154, a tokenization operation may be used to tokenize shopping objects 154 as digital tokens that may be stored locally on client device 110, on edge networks, and/or with corresponding devices for a user associated with client device 110. The tokenization process may issue shopping object tokens 156 as data pieces, strings, alphanumeric characters, or other representations of shopping objects 154 and/or may include a data packet including or representing shopping objects 154. Shopping object tokens 156 may also include object and media metadata 158, as well as other incremental or identifying data for the corresponding shopping object, media content, and the like. For example, object and media metadata may include an identifier or name of the shopping object, other information for the shopping object, a price of the shopping object, a tenant name that provides the media content, time credentials and/or session keys or identifiers, a user private key, and the like.

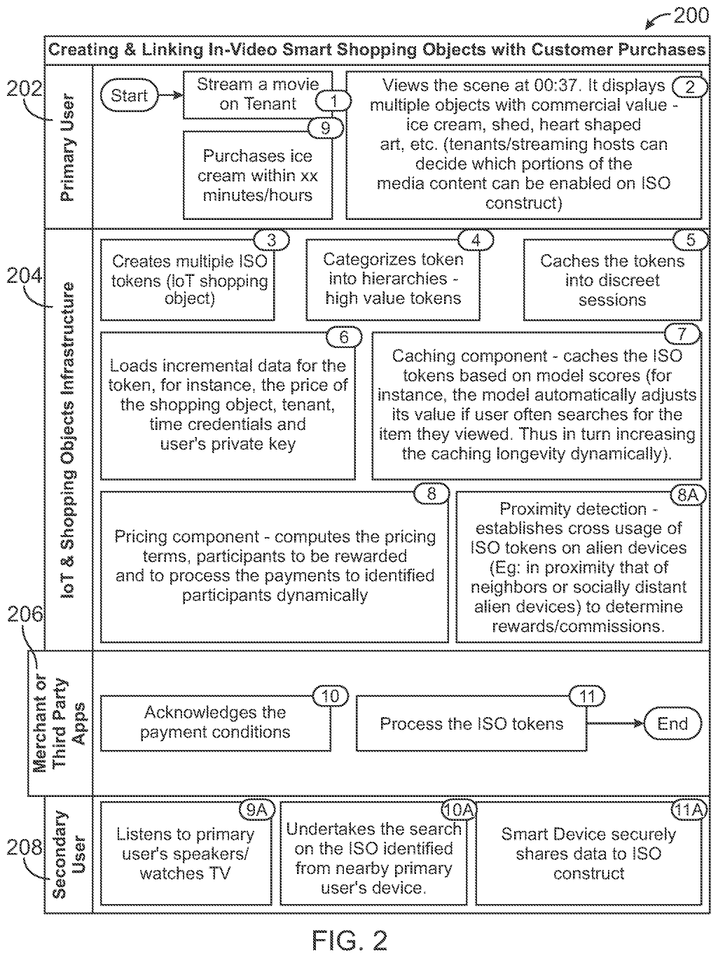

Shopping object tokenization application 150 may then monitor and/or track user behaviors and/or activities to determine if the user is interested in the item presented to the user in the media content and detect a purchase of the item by the user. This may include determining if the user searches for the item, reads reviews of the item, locates the items with physical merchants and merchant location or online digital merchants and marketplaces, and the like. The user may also access an application, including a merchant application and/or item order and delivery application, to find the item, add the item to a cart, and purchase the item, or may perform purchasing activities at a physical merchant location. These behaviors and activities may be linked to shopping object tokens 156 in order to provide rewards and/or payments to entities involved in the presentation of the items in media content and/or sale of the items to users. Transaction processing application 142 may then be used to process one or more purchases of items and distribute rewards for those items. The components and/or operations of shopping object tokenization application 150 are discussed in further detail with regard to FIGS. 2-4 herein.

Transaction processing application 142 may correspond to one or more processes to execute modules and associated specialized hardware of service provider server 140 to process a transaction. Transaction processing application 142 may be used to process payments and other services to one or more users, merchants, and/or other entities for transactions linked to purchasable items in media content tokenized as ISO tokens cached for monitoring and linking to user behaviors. In this regard, transaction processing application 142 may correspond to specialized hardware and/or software used by a user to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 140. In some embodiments, the financial information may also be used to establish a payment account and provide payments through the payment account.

The payment account may be accessed and/or used through a browser application and/or dedicated payment application, which may include, access, and/or be linked to ISO tokens for purchasable items in media content. Transaction processing application 142 may be used to process a transaction, such as using an application/website or at a physical merchant location, for an item that was presented to a user in a media content, including purchasable items 124 in media content 122. Shopping object tokens 156 may correspond to digital ISO tokens generated for purchasable items 124, as well as metadata 126, and may be used to link user behaviors, activities, and/or purchases to a purchase associated with purchasable items 124. When the transaction is processed, the user behaviors and/or activities may indicate that the user requested the purchase based on viewing media content 122 having purchasable items 124. In some embodiments, transaction processing application 142 may further be used to provide rewards, incentives, benefits, and/or portions of a cost or price of a transaction based on the transaction being processed for a purchasable item associated with an ISO token generated in response to media content presenting that item. Transaction processing application 142 may process the payment and may provide a transaction history for transaction authorization, approval, or denial, as well as any rewards, payouts, or share portions provided as a result of a processed transaction.

Additionally, service provider server 140 includes database 144. Database 144 may store various identifiers associated with client device 110. Database 144 may also store account data, including payment instruments and authentication credentials, as well as transaction processing histories and data for processed transactions. Database 144 may further store account data 146, which may be used by shopping object tokenization application 150 when storing shopping object tokens 156 and/or associated those tokens with user behaviors and purchases of items associated with shopping object tokens 156 when presented in media content. As such, account data 146 in database 144 may include information about one or more users' interests, preferences, activities and behaviors, account data, available funds and/or rewards, ISO tokens, and the like. Computer or machine executable instructions may also be stored in database 144 or in a separate storage or database, where the instructions, when executed, enable a system or processor to perform operations as described herein.

In various embodiments, service provider server 140 includes at least one network interface component 148 adapted to communicate client device 110, media viewing device 120, and/or IoT sensors 130, and/or another device/server for a merchant over network 160. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIG. 2 are exemplary interactions 200 between devices and servers of users and other entities when tracking user behaviors with shopping object tokens, according to an embodiment. Interactions 200 include representations of a primary user 202, an IoT and shopping objects infrastructure 204, merchant or third-party applications 206, and a secondary user 208. In this regard, primary user 202 may correspond to a user using client device 110 and/or media viewing device 120 from system 100 of FIG. 1, which may be monitored for media content including items by IoT sensors 130 discussed in reference to system 100. Further, IoT and shopping objects infrastructure 204 may be provided by service provider server 140 discussed in reference to system 100. Interactions 200 may be performed by the users and components of FIG. 2 when generating and utilizing ISO tokens for tracking and linking user behaviors associated with purchasing shopping objects.

At an interaction 1, primary user 202 may stream or otherwise watch a movie on or using a tenant platform, such as a media streaming platform, a television provider, a media viewing service, or the like. Other types of media may also be consumed, such as images and/or audio content, as well as digital content that may include books, articles, comics or graphical novels, presentations including educational materials, and the like. At an interaction 2, the user views a scene at a specific time point in the movie. For example, at 00:37 minutes into the movie, a scene may be presented that includes ice cream (including ice cream of a specific brand), a shed, heart shaped art, and the like. Other types of items may also be viewed or presented to the user, including consumable items or move expensive and/or long-term products including electronics, apparel, art or decorations, vehicles, and the like. These may be presented as a part or background of a scene or other portion of media content, or may also be presented as an advertisement. The tenant providing the media content and/or the creator or producer of the media content may also determine portions of the media content that may be enabled on the ISO token construct and/or the portions of the media content and/or purchasable items that may be ISO enabled.

At an interaction 3, IoT and shopping objects infrastructure 204 creates multiple ISO (IoT shopping object) tokens for the different available items or other shopping objects that may be purchasable in the scene or other portion of the media content. For example, a shopping object may be identified for ice cream within the scene, which may identify the type of item (ice cream), brand of ice cream, flavor or other parameter of the ice cream, sellers of the ice cream, and the like. Similarly, for the heart shaped art, the type and/or parameter of art, artist, online or physical sellers of the art, and the like may be determined. For these shopping objects, ISO tokens may be generated, which correspond to a representation of the shopping object and may be cached in order to associate with user purchasing behaviors. At an interaction 4, IoT and shopping objects infrastructure 204 categorizes the tokens into categories, such as high value tokens. These categories may be based on the interests of the user, past purchases and/or searches of items, value and/or likelihood of purchase by the user (e.g., based on price, item type, or the like), and other information for the shopping object.

At an interaction 5, the ISO tokens are cached into discreet sessions for different media content and/or media viewing/consumption sessions. For example, the user may view one movie, which may correspond to the session for which ISO tokens generated from that movie are cached. A user may also view multiple episodes of a television show in a row, which may also correspond to a singular session or individual sessions for each episode (which may be configurable by the user, tenant providing the media content, and/or service provider for IoT and shopping objects infrastructure 204). This may include caching the ISO tokens with an identifier for the session and/or grouping together for that session and environment for a specific cache, device, edge storage node, or the like. At an interaction 6, incremental data for the token is loaded by IoT and shopping objects infrastructure 204. For example, the price of the shopping object, tenant providing the media, time credentials corresponding to the occurrence of the shopping object in the media content and/or when the media content was viewed, and/or a user's private key may be loaded and associated with each ISO token. In some embodiments, this data may also be tokenized for each ISO token or may be loaded with each ISO token for retrieval and use with each ISO token.

At an interaction 7, a caching component of IoT and shopping objects infrastructure 204 is utilized to further cache and/or adjust the caching of the ISO tokens (as well as any metadata, incremental data, or the like) based on model scores. For example, a rules-based and/or machine learning (ML) model-based engine may be used to adjust values of ISO tokens based on a score or determination of an importance of an item and/or data for a shopping object to a user. In this regard, if the user often searches for and/or purchases the same or similar item, brand, item type (e.g., ice cream), or the like, a corresponding ISO token associated with the item presented in the media content may be increased in importance or value to a user. This may increase a caching longevity of the cached ISO tokens. In some embodiments, this may also increase a likelihood a notification is transmitted to the user notifying them of the item and/or shopping object, which may include the ISO token for local storage and/or usage.

At an interaction 8, a pricing component of IoT and shopping objects infrastructure 204 is utilized to compute the pricing terms and/or participants to be rewarded and to process payments to identified participants dynamically. The pricing component may determine the rewards systems, parameters, and/or payments to be made to different participants and/or entities that are involved in providing the media content and/or item to the user. For example, the participants may correspond to the tenant, a transaction processor, an item purchase and/or delivery application, a producer of the item and/or media content, a seller of the item, a creator of the item (e.g., the artist for heart shaped art in a scene), and the like. At a sub-interaction 8A, proximity detection may be used by IoT and shopping objects infrastructure 204 to establish cross-usage of ISO tokens on alien devices. For example, when in proximity to that of a neighbor or socially distance alien devices, the corresponding user may still consume the media content and/or be aware of the purchasable items. Thus, ISO tokens may also be used with these alien devices and rewards or commissions may also be provided to other users and/or devices that receive these ISO tokens (e.g., the original participant entities from interaction 8, as well as the manufacturer of the television that the neighbor viewed the item on when the media content was played).

At an interaction 9, primary user 202 may process a purchase associated with a shopping object and ISO token within an amount of time associated with the presentation of the media content and/or longevity of caching of the ISO token. For example, the user may purchase ice cream within 30 minutes after viewing the movie. At a sub-interaction 9A, secondary user 208 may also consume the media content, such as by listening to the primary user's speakers and/or by watching the primary user's television. For example, primary user 202 may play a movie, television show, or advertisement via a device, which may be overheard by secondary user 208. When primary user 202 plays the media content, ISO tokens may be generated. However, using the IoT devices and sensors, secondary user 208 may be detected as also consuming the media content. Thus, in the event that a nearby proximal device of secondary user 208 initiates the purchase of a specific item (e.g., an ice cream brand or type) associated with the ISO token(s) from the device of primary user 202, primary user 202 may be reward with a fee or other benefit due to the purchase of an item associated with an ISO token of primary user 202.

At an interaction 10, merchant or third-party applications 206 are used to acknowledge the payment conditions and initiate payment processing, such as with an online transaction processor or other service provider. This may include electronic transaction processing for a payment of the item selected by the user and associated with the item viewed in the media content. At a sub-interaction 10A, secondary user 208 may undertake a search on the ISO token identified from the primary user's device. For example, secondary user 208 may perform a search for the item, which is associated with the ISO token that may be authorized to be shared from sub-interaction 8A on the alien device for secondary user 208. As discussed above, secondary user 208 may perform a search based on viewing, listening to, or otherwise consuming media from the device of primary user 202. As such, the ISO tokens from the device of primary user 202 may be used in order to detect purchases by other users using nearby proximal devices and provide a reward to primary user 202 in addition to any other streamers or providers of media content, creators of the visual art and/or media content, a merchant and/or item delivery service, and/or a transaction processor.

At an interaction 11, the ISO tokens are processed, such as with the electronic transaction processing for the purchase by primary user 202. The ISO token may be processed with an order and/or share that may be provided to each of the participant entities identified from interaction 8. When performing interaction 11, a payment for the item from primary user 202 to a merchant or other seller via merchant or third-party applications 206 and/or another payment or purchase application may be processed. Further, individual rewards and/or payment shares may be processed and/or provided to the participant entities from interaction 8. At an interaction 11A, a device, such as one associated with primary user 202, may securely share the data for the search by secondary user 208, to the ISO construct. This may also include sharing one or more ISO tokens back to one or more devices of the secondary user 208 and/or enabling rewards to participants if secondary user 208 performs a purchase associated with the shopping object(s) and/or ISO token(s).

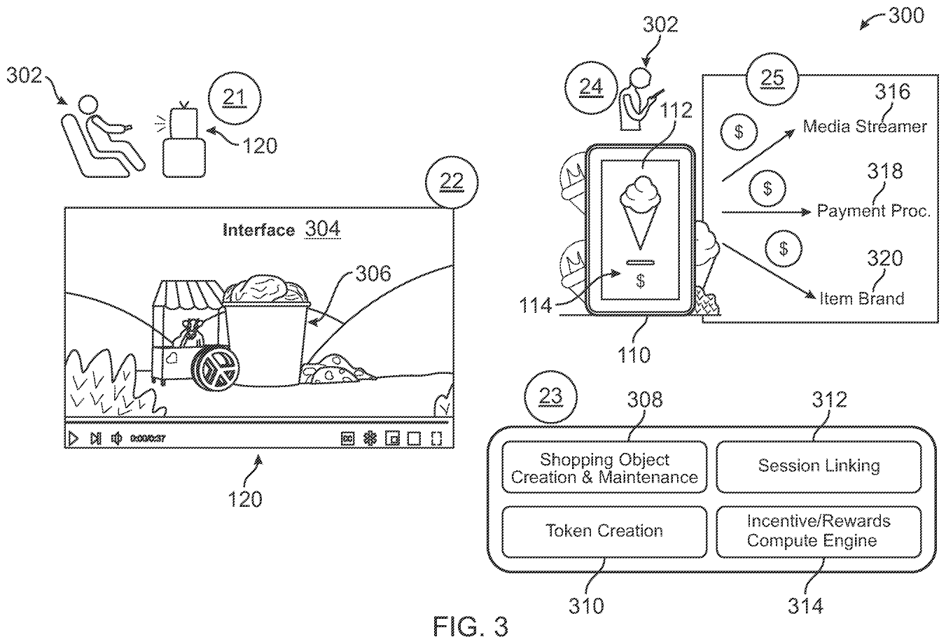

FIG. 3 is an exemplary environment 300 where a user may view media content having purchasable items that may be tokenized as shopping object tokens for user behavior tracking, according to an embodiment. Environment 300 includes client device 110, media viewing device 120, and service provider server 140 discussed in reference to system 100 of FIG. 1. Environment 300 may correspond to an environment where different activities are performed that lead to generation of ISO tokens and providing rewards and/or payments based on purchases linked to those ISO tokens.

In environment 300, during an activity 21, a user 302 utilizes media viewing device 120 to consume media content, such as by viewing a television show, movie, or the like. This may include streaming media content, where a scene from the media content may be view at a time in the media content during activity 22. For example, in interface 304, an item 306 may be included in a scene of the media content. This may be shown in a background, as an advertisement, or as an item interacted with by an actor or other user in the media content. In response to user 302 viewing the media content via interface 304, item 306 may be identified, such as by an IoT sensor or home device. In other embodiments, an Internet router may be used to determine that the media content was streamed, and identification of item 306 may be determined though analysis of the media content and/or metadata for the media content.

During an activity 23, service provider server 140 may execute one or more operations and/or applications for tokenization of shopping object data. For example, service provider server 140 may include shopping object creation and maintenance 308, which may correspond to operations to create shopping objects from one or more purchasable items presented as image, audio, visual, and/or other data objects in media content. Once created, token creation 310 may be used to create ISO tokens and/or other digital payment tokens that may be used to link user behaviors associated with purchases with the shopping objects by caching such tokens. Session linking 312 may be used to link those tokens with media consumption sessions in order to associate tokens with media content.

Further, service provider server 140 includes an incentive/rewards compute engine 314 that allows for determination and provision of rewards, incentives, and/or payment to be provided from participants involved with streaming the media content having item 306 and/or selling the same or similar item to item 306 to user 302. For example, during an activity 24, user 302 may utilize client device 110 to access purchasing application 112 and engage in item purchase 114 for an item associated with item 306 (e.g., the same or similar food type, brand, or flavor of ice cream). A payment may be processed and incentive/rewards compute engine 314 may determine rewards or payments to provide to participating entities in the media content stream and/or sale associated with item purchase 114. During an interaction 25, service provider server then causes the rewards or payments to be processed to different participants. For example, a media streamer 316, a payment processor 318, and/or an item brand 320 may each be rewarded a portion or percentage of the sale, or another reward (e.g., fiat, virtual currency, etc.) may be provided to those participants based on a rewards system.

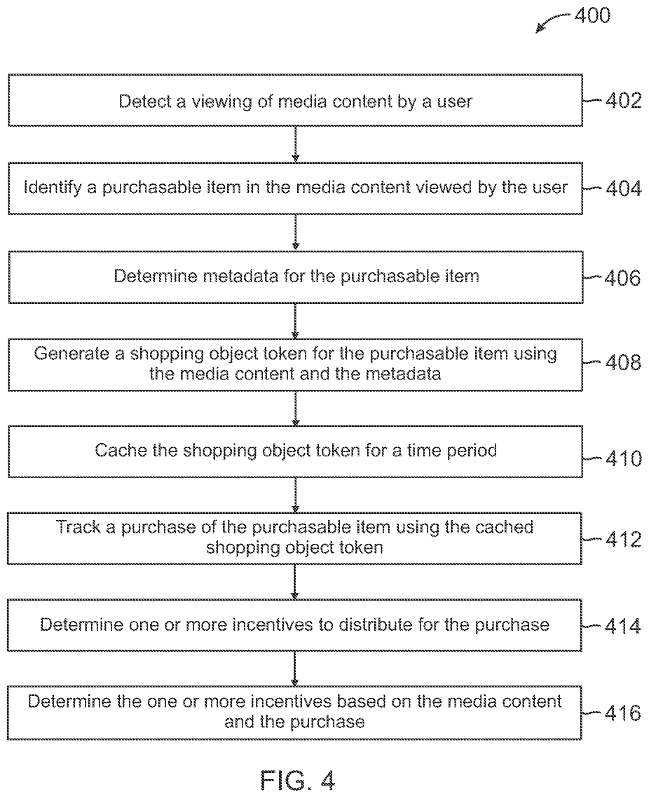

FIG. 4 is a flowchart 400 for linking user behaviors to tracked data consumption using digital tokens, according to an embodiment. Note that one or more steps, processes, and methods described herein of flowchart 400 may be omitted, performed in a different sequence, or combined as desired or appropriate.

At step 402 of flowchart 400, a viewing of media content by a user is detected. Prior to detecting the viewing, an SDK may be provided to the user and/or to a service provider, such as a tenant providing the media content, an IoT provider, a transaction processor, and/or a token service provider. The SDK may be used to configure at least one of an Internet router, a television provider device, a mobile smart phone, an IoT home device, or an IoT sensor using the SDK. The SDK may also be used to provide and/or configure a browser plug-in for a browser application on a computing device, a resident software application or mobile application, and/or a client install software package, which may be used to provide the media content for viewing by the user. This may be done by installing the browser plug-in and/or client software install package on one or more client or computing devices. In some embodiments, the user may be required to opt-in and/or provide permission for service providers, IoT sensors, and the like to monitor media content consumed by the user, such as using an IoT sensor. Permission may be requested and/or granted by the user, and in response, the SDK may also be used to active the IoT sensor(s) to monitor the user viewing the media content.

At step 404, a purchasable item in the media content viewed by the user is identified. For example, the allowed and/or activated IoT sensor(s) may be used to determine that the user is viewing the media content and identify an item in the media content that may be purchasable. Further, an Internet router or other device streaming or outputting the media content may determine when and where items may be presented in media content. At step 406, metadata for the purchasable item is determined. The metadata may correspond to time information for presentation of the purchasable item in the media content, time and/or session information for media content presentation, item information and/or metadata, and/or tenants creating and/or providing the media content to users. The metadata may be used to identify shopping objects for the item and associate those shopping objects with media content and presentation of the media content.

At step 408, a shopping object token is generated for the purchasable item using the media content and the metadata. The shopping object token may be generated using a tokenization process and may tokenize the shopping object for the purchasable item. The shopping object token may correspond to an ISO token usable with a construct and/or infrastructure for ISO token processing, which may allow for tracking and correlating user behaviors associated with searching and/or purchasing items to the shopping object token. At step 410, the shopping object token is cached for a time period. The time period may be based on a user interest and/or value of the shopping object to the user, such as based on a model score from an interest model based on past user activities. The time period may also be associated with the shopping object, such as a shopping object price, value, likelihood of sale, past sale occurrences, and the like.

At step 412, a purchase of the purchasable item is tracked using the cached shopping object token. For example, the user may access one or more merchant and/or third-party applications, such as those associated with item purchasing, ordering, and/or delivery. The user may engage in a purchase, which may be linked to the shopping object token based on the incremental data and/or metadata for the shopping object, as well as the transaction and/or item data for the transaction. This may also include a temporal linking, such as by requiring the purchase to be made within a time frame and/or while the shopping object token is cached.

At step 414, one or more incentives to distribute for the purchase are determined. Once the purchase associated with the shopping object token is determined, linked to the shopping object token, and/or processed, a rewards system may determine one or more rewards or payments to provide to participants involved in the presentation of the purchasable item and/or media content, as well as participants providing the item and/or processing the transaction. This may be rule-based, provide an even share split of a portion or amount from the transaction or determined based on the transaction's total or payment amount, and/or based on another preference or parameter. For example, a seller of an item may be compensated less than creators of the item and/or the media content advertising or presenting the item. At step 416, the one or more incentives are distributed based on the media content and the purchase. This may be provided to accounts and/or digital wallets of the participants identified from step 414. In this manner, different participants involved with an eventual purchase by a user after viewing media content may be automatically identified and rewarded for their efforts.

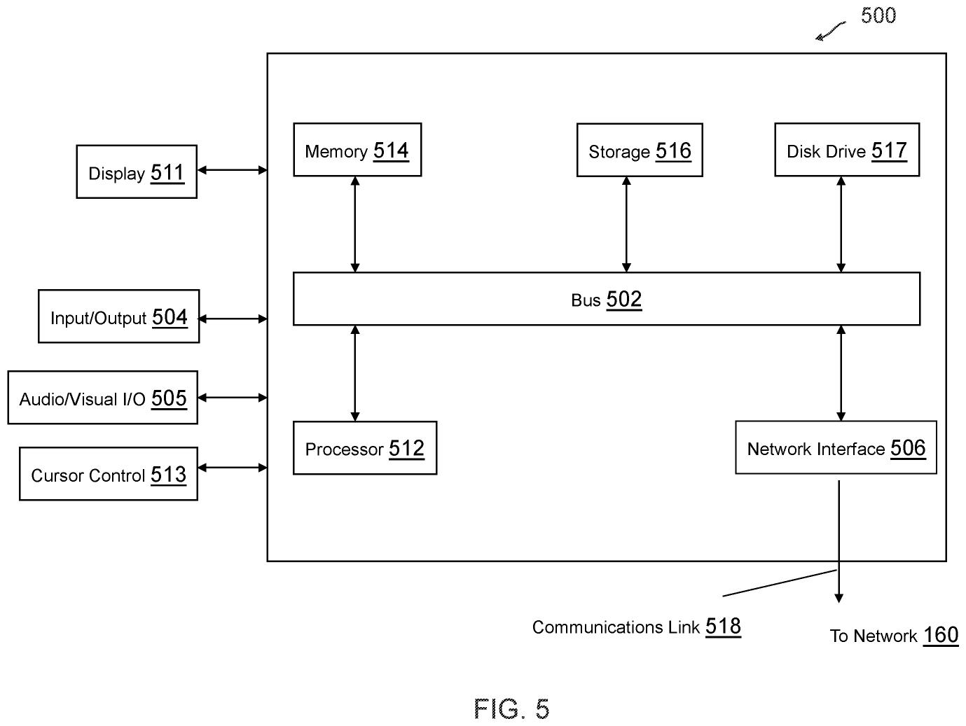

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. For example, while the description focuses on gift cards, other types of funding sources that can be used to fund a transaction and provide additional value for their purchase are also within the scope of various embodiments of the invention. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
detecting a viewing of media content by a user;
determining a data object in the media content that identifies a purchasable item associated with the media content;
associating the data object with metadata for the data object based on the viewing of the media content by the user;
tokenizing the data object in the media content as a shopping object token, wherein the metadata is tokenized with the data object for the shopping object token;
caching the shopping object token for the data object and the user;
tracking the data object on at least one purchasing platform using the shopping object token cached for the user; and
determining whether a purchase, by the user, of an item associated with the purchasable item for the data object is processed based on the tracking.

2. The service provider system of claim 1, wherein, in response to determining that the purchase is processed, the operations further comprise:
determining a plurality of parties associated with providing the media content with the purchasable item to the user and processing the purchase of the item; and
providing a plurality of shares of an incentive to the plurality of parties.

3. The service provider system of claim 2, wherein the plurality of parties comprise at least one of a merchant selling the item, an advertiser of the item, a producer of the item, or a producer of the media content.

4. The service provider system of claim 1, wherein prior to the detecting the viewing of the media content by the user, the operations further comprise:
providing a software development kit (SDK) to at least one of the user or a computing service provider associated with providing the media content to the user; and
configuring at least one of an Internet router, a television provider device, a mobile smart phone, an Internet of Things (IoT) home device, or an IoT sensor using the SDK.

5. The service provider system of claim 4, wherein the SDK is further used to provide or configure one of a browser plug-in for a browser application, a resident software application, or a client install software package that are used to provide the viewing of the media content to the user.

6. The service provider system of claim 1, wherein the data object comprises a representation of the purchasable item in the media content, and wherein the representation comprises one of a use of the purchasable item by an actor in the media content, an advertisement of the purchasable item in the media content, or a display of the purchasable item in the media content.

7. The service provider system of claim 1, wherein the detecting the viewing of the media content by the user is performed using one of a smart television of the user or IoT sensor for the user.

8. The service provider system of claim 1, wherein the caching the shopping object token for the data object is with a streaming segment of the media content for a time period.

9. The service provider system of claim 8, wherein the caching uses a public key for the user that is maintained with a viewing session for the streaming segment of the media content.

10. The service provider system of claim 1, wherein prior to the tracking the data object, the operations further comprise:
transmitting a digital communication identifying the data object in the media content to the user, wherein the digital communication comprises one of an email, a text message, or an on-screen visual alert within the media content.

11. The service provider system of claim 10, wherein the operations further comprise:
processing the purchase of the item, using the shopping object token, on a digital shopping platform based on the digital communication.

12. A method comprising:
determining that a user is viewing an item in a scene in video content using at least one Internet of Things (IoT) sensor, wherein the item is viewed at a time during playback of the video content;
determining metadata associated with the user viewing the item in the scene based on the video content and the time, wherein the metadata is associated with at least one parameter of the item when viewed in the video content;
generating a digital token for an IoT shopping object for the item and the metadata;
caching the digital token for a time period for the user and the item;
determining a purchase of the item using a digital shopping platform based on the cached digital token; and
providing an incentive to at least one entity associated with one or more of the video content or the purchase of the item using the digital shopping platform.

13. The method of claim 12, wherein prior to the determining that the user is viewing the item, the method further comprises:
requesting a permission to monitor video contents viewed by the user using the at least one IoT sensor for the user;
receiving the permission from the user; and
activating, using a software development kit (SDK), the at least one IoT sensor for monitoring the video contents.

14. The method of claim 13, wherein prior to the activating, the method further comprises:
installing one of a browser plug-in for a browser accessing a web application corresponding to the video content or a client application install package for a resident software application corresponding to the video content using the SDK.

15. The method of claim 12, wherein the at least one entity comprises at least one of a merchant selling the item to the user, a creator of the video content, a provider of the video content, or an actor in the video content, and wherein the providing the incentive to the at least one entity comprises:
determining a share of a monetary reward to provide to each of the at least one entity; and
providing the share of the monetary reward to each of the at least one entity.

16. The method of claim 12, wherein prior to the determining the purchase, the method further comprises:
determining that the user does not have an account with a transaction processor that generates the digital token; and
requesting that the user onboard with the transaction processor for the account, wherein the requesting provides the digital token to a device of the user.

17. The method of claim 12, wherein the time period is variable in longevity based on a type of the item.

18. The method of claim 12, wherein the IoT sensor comprises one of a smart television, an Internet router, a mobile smart phone, a cable television box, a microphone, a camera, or a touch screen interface.

19. A non-transitory machine-readable medium having stored thereon machine-readable instructions executable to cause a machine to perform operations comprising:
identifying an item in media content being consumed by a user using at least one of a sensor or a device associated with the user, wherein the item is further associated with item metadata based on a presentation of the item in the media content;
caching the item with a media consumption session of the user based on the identifying the item in the media content, wherein the item is cached as a digital token associated with a shopping object for the item associated with the media consumption session;
detecting a purchase of the item by the user from a merchant using a digital shopping platform and the digital token associated with the shopping object for the item;
determining a reward to provide to at least one of an originator of the media content or the merchant based on the purchase; and
providing the reward to the at least one of the originator or the merchant.

20. The non-transitory machine-readable medium of claim 19, wherein the media content consumed by the user comprises one of a movie, a television show, a streaming video content, an audio broadcast, or a podcast.
